(19) United States
(12) Patent Application Publication
(10) Pub. No.: US 2026/0129351 A1
(43) Pub. Date: May 7, 2026

(54) EARPHONES

(71) Applicant: SHENZHEN SHOKZ CO., LTD., Shenzhen (CN)

(72) Inventors: Zhao XIE, Shenzhen (CN); Shuailin XIE, Shenzhen (CN)

(73) Assignee: SHENZHEN SHOKZ CO., LTD., Shenzhen (CN)

(21) Appl. No.: 19/437,276

(22) Filed: Dec. 30, 2025

Related U.S. Application Data
(63) Continuation of application No. PCT/CN2024/084204, filed on Mar. 27, 2024.

(51) Int. Cl. H04R 1/10; H04R 1/02

(52) U.S. Cl. CPC H04R 1/1075; H04R 1/025; H04R 2460/13

(57) ABSTRACT

The present disclosure provides an earphone including a housing assembly, an air-conduction speaker, and a bone-conduction speaker. The housing assembly includes a first housing and a second housing. The second housing engages with the first housing, and the first housing and the second housing mate with each other to form a first accommodating cavity and a second accommodating cavity. The air-conduction speaker is disposed in the first accommodating cavity. The bone-conduction speaker is disposed in the second accommodating cavity. The second housing is configured to contact a face of a user in a wearing state, and an engagement seam between the first housing and the second housing does not contact the face of the user.

### CROSS REFERENCE TO RELATED APPLICATIONS

This application is a continuation of International Application No. PCT/CN2024/084204 filed on Mar. 27, 2024, the entire contents of which are incorporated herein by reference.

### TECHNICAL FIELD

The present disclosure relates to the field of electronic devices, and in particular, to an earphone.

### BACKGROUND

With the continuous popularization of electronic devices, the electronic devices have become indispensable social and entertainment tools in people's daily lives, and people's requirements for the electronic devices are also increasing. The electronic devices such as earphones and smart glasses have been widely used in people's daily lives. They may be used in conjunction with terminal devices such as mobile phones and computers to provide users with an auditory feast.

However, current earphone housings generally use an assembly structure, which may result in an engagement seam in the area where the earphone fits the face of the user. Moreover, during daily use, the engagement seam of the earphone housing may pinch the face of the user, and sweat from the face of the user may enter the earphone through the engagement seam, affecting the electronic components inside the earphone.

### SUMMARY

To this end, the present disclosure provides an earphone, which can solve the problems in the prior art that the engagement seam of the earphone housing may pinch the face of the user and sweat may enter the earphone through the engagement seam during use.

One or more embodiments of the present disclosure provide an earphone. The earphone includes a housing assembly, an air-conduction speaker, and a bone-conduction speaker. The housing assembly includes a first housing and a second housing. The second housing engages with the first housing. The first housing and the second housing mate with each other to form a first accommodating cavity and a second accommodating cavity. The air-conduction speaker is disposed in the first accommodating cavity. The bone-conduction speaker is disposed in the second accommodating cavity. The second housing is configured to contact a face of a user in a wearing state, and an engagement seam between the first housing and the second housing does not contact the face of the user.

By controlling the engagement seam of the housing assembly not to contact the face of the user, the risk of the engagement seam of the housing assembly pinching the face of the user can be reduced, and additionally, the risk of sweat from the face of the user entering the housing assembly through the engagement seam can be further reduced.

In some embodiments, the first housing includes a first sub-accommodating cavity and a second sub-accommodating cavity. The first sub-accommodating cavity is at least a part of the first accommodating cavity. The second sub-accommodating cavity is at least a part of the second accommodating cavity. The first sub-accommodating cavity includes a first opening. The second sub-accommodating cavity includes a second opening. An axial direction of the first opening and an axial direction of the second opening form an angle.

In some embodiments, the second housing includes a main portion and an extension portion, and the main portion and the extension portion form an integral structure. The main portion covers the first opening and mates with the first housing to form the first accommodating cavity, and the extension portion covers the second opening and mates with the first housing to form the second accommodating cavity.

In some embodiments, at least a part of the air-conduction speaker is disposed in the first sub-accommodating cavity through the first opening. At least a part of the bone-conduction speaker is disposed in the second sub-accommodating cavity through the second opening. An axial direction of the air-conduction speaker is the same as the axial direction of the first opening. An axial direction of the bone-conduction speaker is the same as the axial direction of the second opening.

In some embodiments, the axial direction of the first opening is perpendicular to the axial direction of the second opening.

In some embodiments, an outer contour of the main portion is frustum-shaped, and a cross-section of the extension portion in a plane perpendicular to an extension direction of the extension portion is C-shaped; and/or in a direction perpendicular to both a vibration direction of the air-conduction speaker and a vibration direction of the bone-conduction speaker, a shape of a projection of the second housing is L-shaped.

In some embodiments, the first housing includes a main housing and a first annular flange. The main housing includes a bottom wall portion and an annular side wall portion connected to each other. The first annular flange is protrudingly disposed on an outer side of the annular side wall portion. The bottom wall portion and the annular side wall portion enclose at least a part of the second accommodating cavity. The first annular flange and a part of the annular side wall portion form at least a part of the first accommodating cavity.

In some embodiments, an inner surface of the first annular flange is provided with a first step portion. The first step portion is configured to support a bottom end surface of the air-conduction speaker facing the annular side wall portion. The annular side wall portion is provided with a first groove included in the first accommodating cavity.

In some embodiments, an inner surface of the annular side wall portion is provided with a second step portion. The second step portion is configured to support a bottom end surface of the bone-conduction speaker facing the bottom wall portion. The bottom wall portion is provided with a second groove included in the second accommodating cavity.

In some embodiments, the first annular flange includes an annular wall and a semi-enclosed portion. The annular wall is configured to form the first accommodating cavity. Along the vibration direction of the bone-conduction speaker, the semi-enclosed portion encloses an outer side of the annular wall close to the bottom wall portion. A part of an outer surface of the annular wall close to the semi-enclosed portion is configured to engage with the second housing, and an end surface of the semi-enclosed portion facing the second housing is configured to engage with the second housing.

In some embodiments, the annular side wall portion includes a first side wall portion and a second side wall portion connected to each other, and the first annular flange is protrudingly disposed on an outer side of the first side wall portion. An end surface of the annular side wall portion and the end surface of the semi-enclosed portion are smoothly connected to form a first annular curved surface, and the end surface of the annular side wall portion is configured to engage with the second housing.

In some embodiments, the end surface of the semi-enclosed portion gradually moves away from an end surface of the annular wall along a direction along a depth direction of the first accommodating cavity and toward the second accommodating cavity.

In some embodiments, the first housing and the second housing are fixed by a limit structure.

In some embodiments, on a side away from the second accommodating cavity, a first limit block is protrudingly disposed on the end surface of the annular wall. The second housing is provided with a corresponding first limit groove, the first limit block being clamped in the first limit groove.

In some embodiments, the first housing includes a support block, the support block being configured to support the second housing.

In some embodiments, along the vibration direction of the bone-conduction speaker and on a side close to the second accommodating cavity, a support block is disposed on an outer surface of the annular wall, the support block being configured to support the second housing.

In some embodiments, a plurality of support blocks are arranged in a spaced manner; and/or as gradually approaching the second accommodating cavity, heights of the plurality of support blocks on the outer surface of the annular wall gradually increase; and/or an inner surface of the second housing is provided with a third groove, the third groove being configured to mate with the support block.

In some embodiments, along the vibration direction of the bone-conduction speaker and on a side close to the second accommodating cavity, a protrusion is disposed on the outer surface of the annular wall. The protrusion extends circumferentially along the annular wall, an inner surface of the second housing is provided with a fourth groove, and the protrusion mates with the fourth groove.

In some embodiments, the protrusion and the fourth groove are connected by an adhesive.

In some embodiments, at least on a side away from the semi-enclosed portion, the end surface of the annular wall and the outer surface of the annular wall are connected by a chamfered surface.

In some embodiments, on a side away from the first accommodating cavity, a second limit block is protrudingly disposed on the end surface of the annular side wall portion. The second housing is provided with a corresponding second limit groove, the second limit block being clamped in the second limit groove.

In some embodiments, the first housing is provided with an ear hook connecting portion. In the vibration direction of the air-conduction speaker, the bone-conduction speaker is closer to the ear hook connecting portion than the air-conduction speaker.

In some embodiments, the second housing has a planar contact area contacting the face of the user in a use state. In a normal direction of the planar contact area, a height difference between the planar contact area and the engagement seam is greater than 0.5 mm.

In some embodiments, the bone-conduction speaker has an upper end surface and a bone-conduction bottom end surface oppositely disposed in the vibration direction of the bone-conduction speaker. A center axis of the air-conduction speaker is located between the upper end surface and the bone-conduction bottom end surface. A ratio of a distance between the center axis and the upper end surface to a distance between the upper end surface and the bone-conduction bottom end surface is 40%-70%.

### BRIEF DESCRIPTION OF THE DRAWINGS

To more clearly illustrate the technical solutions in the embodiments of the present disclosure, the drawings required for describing the embodiments will be briefly introduced below. Obviously, the drawings in the following description are only some embodiments of the present disclosure, and for those of ordinary skill in the art, other drawings may be obtained based on these drawings without creative effort.

FIG. 1 is a schematic diagram of an overall structure of an earphone according to some embodiments of the present disclosure;

FIG. 2 is a schematic diagram of a structure of a core assembly of an earphone according to some embodiments of the present disclosure;

FIG. 3 is a schematic diagram of an exploded structure of a core assembly of an earphone according to some embodiments of the present disclosure;

FIG. 4 is a schematic diagram of a front contour of an ear of a user according to some embodiments of the present disclosure;

FIG. 5 is a schematic diagram of a cross-sectional structure of a core assembly of an earphone along section line A-A according to some embodiments of the present disclosure;

FIG. 6 is a schematic diagram of a structure of a first housing of a core assembly of an earphone according to some embodiments of the present disclosure;

FIG. 7 is a schematic diagram of a structure of a second housing of a core assembly of an earphone according to some embodiments of the present disclosure;

FIG. 8 is another schematic diagram of a structure of a second housing of a core assembly of an earphone according to some embodiments of the present disclosure; and

FIG. 9 is a schematic diagram of a structure of a microphone assembly disposed on a first housing of an earphone according to some embodiments of the present disclosure.

### DETAILED DESCRIPTION

To enable those skilled in the art to better understand the technical solutions of the present disclosure, the earphone provided by the present disclosure will be further described in detail below with reference to the accompanying drawings and specific embodiments. It should be understood that the described embodiments are only a part of the embodiments of the present disclosure, and not all embodiments. Based on the embodiments in the present disclosure, all other embodiments obtained by those of ordinary skill in the art without creative effort shall fall within the protection scope of the present disclosure.

The terms “first”, “second”, etc., in the present disclosure are used to distinguish different objects, rather than to describe a specific order. In addition, the terms “include” and “have” and any variations thereof are intended to cover non-exclusive inclusion. For example, a process, method, system, product, or device that includes a series of steps or units is not limited to the listed steps or units, but optionally also includes steps or units not listed, or optionally also includes other steps or units inherent to these processes, methods, products, or devices.

The inventors of the present disclosure have found that, currently, for many core assemblies, a housing assembly thereof is usually assembled from at least two housings. The position of an engagement seam formed during the assembly process of the housing assembly makes it easy to contact a face of a user during wearing. In this case, the engagement seam may pinch the face of the user, reducing the user's wearing experience. In addition, due to the existence of the engagement seam, sweat during use may enter the housing assembly through the engagement seam, and may further negatively affect electronic components inside the housing assembly (such as a circuit board, a speaker, or a microphone).

To solve the above problems, some embodiments of the present disclosure provide an earphone 100a, which includes a core assembly 1, an ear hook assembly 2, and a rear hook assembly 3.

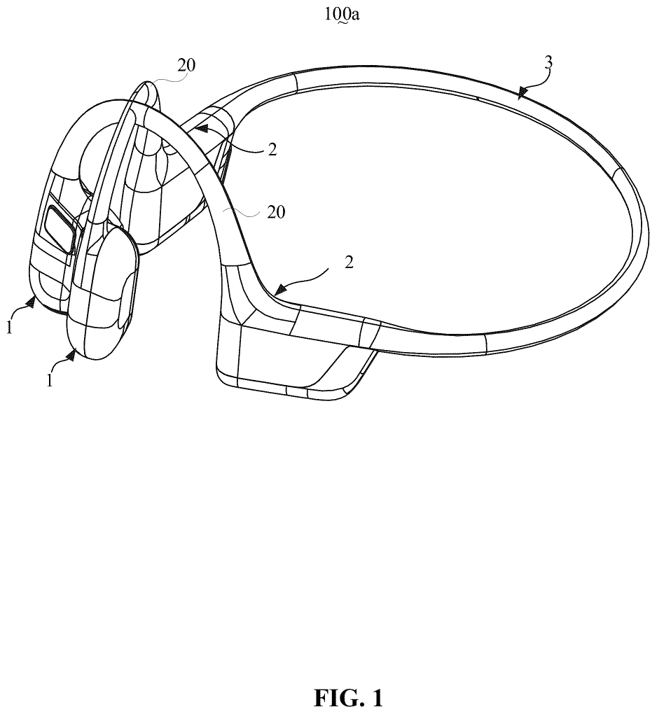

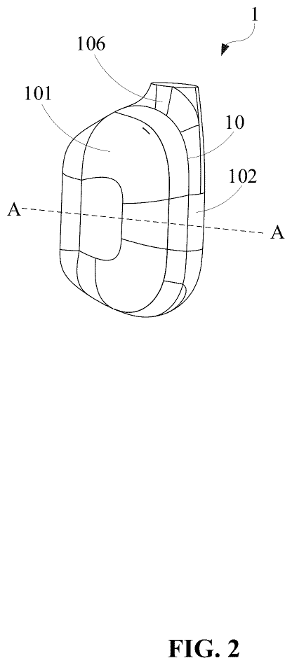

Referring to FIGS. 1, 2, and 3, a count of the core assembly 1 may be two. The two core assemblies 1 are respectively configured to transmit vibration and/or sound to a left ear and a right ear of a user. The core assembly 1 may include a housing assembly 10, a bone-conduction speaker 11, and an air-conduction speaker 12. The bone-conduction speaker 11 and the air-conduction speaker 12 may be disposed in the housing assembly 10. The air-conduction speaker 12 transmits sound to the user's ear canal through a principle of air vibration, and the bone-conduction speaker 11 transmits sound to the user through bone conduction vibration. The two core assemblies 1 may be the same or different. For example, one core assembly 1 may be provided with a microphone, while the other core assembly 1 may not be provided with the microphone. As another example, one core assembly 1 may be provided with a button and a corresponding circuit board, while the other core assembly 1 may not be provided with the button and the corresponding circuit board. The two core assemblies 1 may be the same in terms of a core module (e.g., a speaker module). The core assembly 1 described below may be considered as an example of one of the two core assemblies 1 for a detailed description.

A count of the ear hook assembly 2 may be two. The two ear hook assemblies 2 may be respectively hooked on the left ear and the right ear of the user, so that the core assembly 1 may fit a face of the user. The two ear hook assemblies 2 may include an ear hook 20 hooked on the ear of the user. One end of the ear hook assembly 2 is connected to the core assembly 1, and the other end of the ear hook assembly 2 is connected to the rear hook assembly 3. The two ear hook assemblies 2 may be the same or not completely the same. For example, one ear hook assembly 2 may be provided with a battery, and the other ear hook assembly 2 may be provided with a circuit board and an antenna assembly, etc. The circuit board may be electrically connected to at least one of the battery, the bone-conduction speaker 11, the air-conduction speaker 12, the microphone, or the antenna assembly.

The rear hook assembly 3 connects the two ear hook assemblies 2. The rear hook assembly 3 is configured to wrap around a neck rear side or a head rear side of the user and may provide a clamping force, so that the two core assemblies 1 are clamped on both sides of the face of the user and the ear hook assembly 2 is more stably hooked on the ear of the user. Of course, the earphone 100a may not include the rear hook assembly 3, and the core assembly 1 is worn on the ear of the user through the ear hook assembly 2.

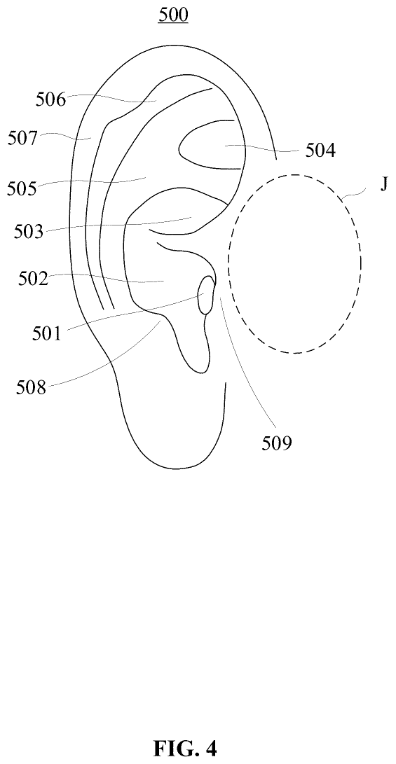

With reference to FIG. 4, the ear 500 of the user may include physiological parts such as an external auditory canal 501, a cavum conchae 502, a cymba conchae 503, a triangular fossa 504, an antihelix 505, a scaphoid fossa 506, a helix 507, an antitragus 508, and a helix crus 509. Although the external auditory canal 501 has a certain depth and extends to an eardrum of the ear 500, for the convenience of description and with reference to FIG. 4, in the present disclosure, unless otherwise specified, the external auditory canal 501 specifically refers to its entrance away from the eardrum (i.e., an ear hole). Furthermore, the physiological parts such as the cavum conchae 502, the cymba conchae 503, and the triangular fossa 504 have a certain volume and depth, and the cavum conchae 502 is directly connected to the external auditory canal 501, that is, it may be simply regarded that the ear hole is located at a bottom of the cavum conchae 502.

In some embodiments, one or more parts of the ear 500 may be used to achieve the wearing and stability of the earphone 100a. In some embodiments, parts such as the external auditory canal 501, the cavum conchae 502, the cymba conchae 503, and the triangular fossa 504 have a certain depth and volume in three-dimensional space, which can be used to achieve the wearing requirements of the earphone.

Usually, the core assembly 1 is located on a front side of the ear 500 in a wearing state, and the ear hook assembly 2 is located on a rear side of the ear 500 in the wearing state, so that the earphone 100a is hooked on the ear 500 in the wearing state. The core assembly 1 may have a connecting end connected to the ear hook assembly 2 and a free end not connected to the ear hook assembly 2. In some embodiments, the core assembly 1 may be configured not to block the external auditory canal 501 in the wearing state, so that the earphone 100a serves as an “open earphone”. Due to individual differences among different users, when the earphone 100a is worn by different users, the core assembly 1 may partially block the external auditory canal 501, but the external auditory canal 501 is still not blocked.

In some embodiments, the open earphone (e.g., the earphone 100a) may be worn by using parts such as the cymba conchae 503, the triangular fossa 504, the antihelix 505, the scaphoid fossa 506, the helix 507, or a combination thereof. In some embodiments, to improve the wearing comfort and reliability of the earphone, parts such as an earlobe of the user may be further used. By using other parts of the ear 500 except the external auditory canal 501 to achieve the wearing of the earphone and the transmission of sound, the external auditory canal 501 of the user may be “liberated,” reducing the impact of the earphone on the ear health of the user. When the user wears the earphone on the road, the earphone does not block the external auditory canal 501 of the user, and the user can receive both sound from the earphone and sound from the environment (e.g., horn sounds, bicycle bell sounds, surrounding human voices, traffic command sounds, etc.), thereby reducing the probability of traffic accidents. For example, when the user wears the earphone, an overall structure or a part structure of the earphone may be located on a front side of the crus of helix 509 (e.g., an area J enclosed by dashed lines in FIG. 4).

Furthermore, different users may have individual differences, leading to variations in the shape, size, and other dimensions of the ear. For ease of description and to reduce (or even eliminate) individual differences among users, a simulator containing a head and its (left and right) ears EAR may be manufactured based on standards ANSI:S3.36, S3.25, and IEC:603187, such as the GRAS 45BC KEMAR. Therefore, descriptions such as “the user wears an earphone,” “the earphone is in a wearing state,” and “in the wearing state” refers to the earphone described in the present disclosure being worn on the ear of the simulator. Of course, precisely because different users have individual differences, there may be some discrepancies when the earphone is worn by different users compared with when it is worn on the ear of the simulator, but such discrepancies should be tolerable.

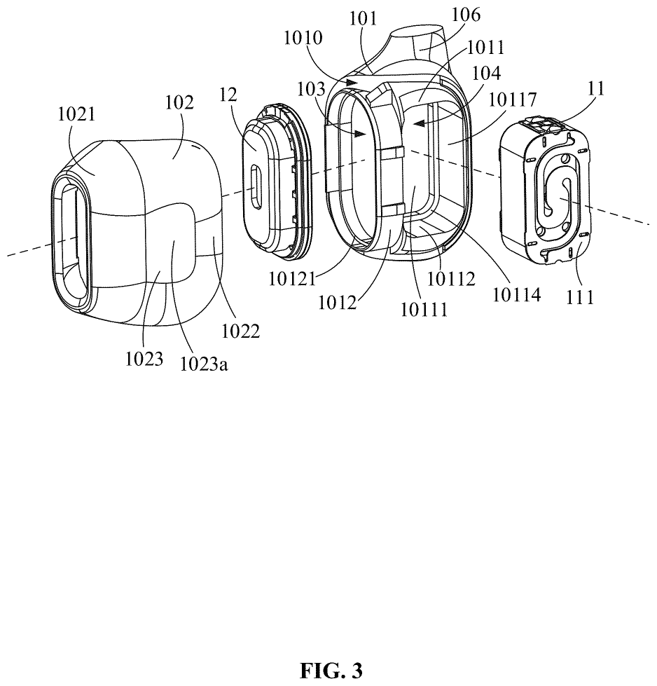

Referring to FIG. 3, the housing assembly 10 may include a first housing 101 and a second housing 102. The second housing 102 may engage with the first housing 101, and the first housing 101 and the second housing 102 mate with each other to form a first accommodating cavity 103 and a second accommodating cavity 104. The first accommodating cavity 103 and the second accommodating cavity 104 are spaced apart. The air-conduction speaker 12 is disposed in the first accommodating cavity 103, and the bone-conduction speaker 11 is disposed in the second accommodating cavity 104. The second housing 102 is configured to contact the face of the user in the wearing state, and an engagement seam between the first housing 101 and the second housing 102 does not contact the face of the user.

That is, the housing assembly 10 (especially the second housing 102) may have a contact area 1023 that fits the face of the user when the earphone 100a is worn. The contact area 1023 may be a planar structure, a curved surface structure, or a combination of both. The engagement seam between the second housing 102 and the first housing 101 may be located outside the contact area 1023. By controlling the engagement seam of the housing assembly 10 not to contact the face of the user, the risk of the engagement seam of the housing assembly 10 pinching the face of the user can be reduced, and the user's comfort can be improved. In addition, the risk of sweat from the face of the user entering the housing assembly 10 through the engagement seam can be further reduced. It should be noted that the contact area 1023 may be a part that contacts the facial area (area J) near the external auditory canal 501 of the simulator when the earphone 100a is worn on the simulator.

Referring to FIGS. 3, 5, and 6, in some embodiments, the first housing 101 includes a first sub-accommodating cavity 1015 and a second sub-accommodating cavity 1016. The first sub-accommodating cavity 1015 is at least a part of the first accommodating cavity 103, and the second sub-accommodating cavity 1016 is at least a part of the second accommodating cavity 104. It may be understood that the first accommodating cavity 103 and the second accommodating cavity 104 are both defined by the first housing 101 and the second housing 102 together. A part of the first accommodating cavity 103 located in the first housing 101 is the first sub-accommodating cavity 1015, and a part of the second accommodating cavity 104 located in the first housing 101 is the second sub-accommodating cavity 1016. A main part of the second accommodating cavity 104 is defined by the first housing 101.

The first sub-accommodating cavity 1015 includes a first opening 1017, and the second sub-accommodating cavity 1016 includes a second opening 1018. An axial direction of the first opening 1017 and an axial direction of the second opening 1018 form an angle. The axial direction of the first opening 1017 is a direction of a line connecting a center of the first opening 1017 and a center of a bottom wall of the first sub-accommodating cavity 1015, and the axial direction of the second opening 1018 is a direction of a line connecting a center of the second opening 1018 and a center of a bottom wall of the second sub-accommodating cavity 1016. It may be understood that the first housing 101 is provided with the first opening 1017 and the second opening 1018, and the first opening 1017 and the second opening 1018 face different directions.

Referring to FIG. 3, in some embodiments, the second housing 102 includes a main portion 1021 and an extension portion 1022. The extension portion 1022 is configured to contact the face of the user. That is, the contact area 1023 is disposed on the extension portion 1022. The main portion 1021 covers the first opening 1017 and mates with the first housing 101 to form the first accommodating cavity 103. The extension portion 1022 covers the second opening 1018 and mates with the first housing 101 to form the second accommodating cavity 104. The extension portion 1022 is connected to the main portion 1021, for example, the extension portion 1022 may extend from a side of the main portion 1021 close to the second accommodating cavity 104 along a direction parallel to the axial direction of the first opening 1017. The main portion 1021 and the extension portion 1022 form an integral structure. The main portion 1021 and the extension portion 1022 may be made of the same material, for example, the main portion 1021 and the extension portion 1022 may be integrally formed by injection molding using the same plastic. The main portion 1021 and the extension portion 1022 may further engage with the first housing 101 to form the engagement seam between the first housing 101 and the second housing 102. Compared with an earphone formed by combining three or more housings, the embodiment of the present disclosure uses only the first housing 101 and the second housing 102 to cooperate, which can reduce a count of exposed engagement seams, reduce the workload of glue dispensing, and also improve the overall sealing of the housing assembly 10, making the structure of the core assembly 1 tighter and more reliable.

In some embodiments, at least a part of the air-conduction speaker 12 is disposed in the first sub-accommodating cavity 1015 through the first opening 1017, and at least a part of the bone-conduction speaker 11 is disposed in the second sub-accommodating cavity 1016 through the second opening 1018. An axial direction of the air-conduction speaker 12 is the same as the axial direction of the first opening 1017, and an axial direction of the bone-conduction speaker 11 is the same as the axial direction of the second opening 1018. The axial direction of the first opening 1017 and the axial direction of the second opening 1018 form an angle, which can facilitate the installation of the air-conduction speaker 12 and the bone-conduction speaker 11. Since the axial direction of the air-conduction speaker 12 is the same as the axial direction of the first opening 1017, and the axial direction of the bone-conduction speaker 11 is the same as the axial direction of the second opening 1018, a vibration direction of the air-conduction speaker 12 installed at the first opening 1017 and a vibration direction of the bone-conduction speaker 11 installed at the second opening 1018 also form an angle, thereby avoiding the vibration of the bone-conduction speaker 11 from affecting the vibration of a diaphragm of the air-conduction speaker 12. At the same time, the opening manner of the first opening 1017 and the second opening 1018 can also make the separation and sealing effect between the first accommodating cavity 103 and the second accommodating cavity 104 better.

In some embodiments, the axial direction of the first opening 1017 is perpendicular to the axial direction of the second opening 1018. Accordingly, the vibration direction of the air-conduction speaker 12 is perpendicular to the vibration direction of the bone-conduction speaker 11, which can further reduce the influence of the bone-conduction speaker 11 on the air-conduction speaker 12.

In this way, since the engagement seam between the first housing 101 and the second housing 102 is located outside the contact area 1023, the risk of the engagement seam of the housing assembly 10 pinching the face of the user can be reduced, and the risk of sweat from the face of the user entering the housing assembly 10 through the engagement seam can be further reduced. Moreover, the housing assembly 10 includes the first housing 101 and the second housing 102, which can reduce a count of exposed engagement seams of the housing assembly 10 that may contact the face of the user, and improve the wearing comfort of the earphone 100a.

In a structure where the engagement seam fits the face of the user, the existence of the engagement seam may have a negative effect on the bone conduction of sound. However, in the present disclosure, the second housing 102 has a larger surface area, thereby increasing an effective area (i.e., a contact area between the second housing 102 and the face of the user) of bone conduction when the bone-conduction speaker 11 works, and improving the effect of bone conduction. In addition, an area of a housing part (i.e., the extension portion 1022 of the second housing 102) on a side of the bone-conduction speaker 11 facing the face of the user and an area of a housing part (i.e., the part of the first housing 101) on a side of the bone-conduction speaker 11 away from the face of the user are approximately equal, which can improve the sound leakage cancellation effect of the bone-conduction speaker 11, thereby improving the sound leakage reduction effect.

Referring to FIGS. 3, 5, and 7, in some embodiments, an outer contour of the main portion 1021 is frustum-shaped. A cross-sectional area of the main portion 1021 at an end close to the extension portion 1022 is greater than a cross-sectional area of the main portion 1021 at an end away from the extension portion 1022. A cross-section of the extension portion 1022 in a plane perpendicular to the extension direction of the extension portion 1022 is C-shaped. That is, the cross-section of the extension portion 1022 in a plane parallel to the axial direction of the second opening 1018 is C-shaped. The extension portion 1022 extends from a side of the main portion 1021 close to the second accommodating cavity 104 along a direction parallel to the axial direction of the first opening 1017. Both sides of the extension portion 1022 parallel to the extension direction respectively bend and extend toward a direction close to the second accommodating cavity 104, forming a housing with a certain curvature on the surface. The shape of the extension portion 1022 enables the engagement seam between the first housing 101 and the second housing 102 not to contact the face of the user, thereby reducing the risk of the engagement seam pinching the face of the user.

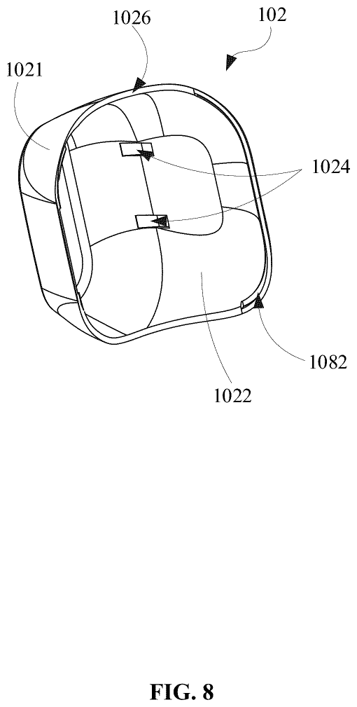

Referring to FIGS. 3 and 8, in some embodiments, in a direction perpendicular to both the vibration direction of the air-conduction speaker 12 and the vibration direction of the bone-conduction speaker 11, a shape of a projection of the second housing 102 is L-shaped. It may be understood that on a plane parallel to the axial direction of the first opening 1017 and the axial direction of the second opening 1018, the shape of the projection of the second housing 102 is L-shaped. That is, the second housing 102 is overall an L-shaped housing, and the second housing 102 semi-surrounds the first housing 101.

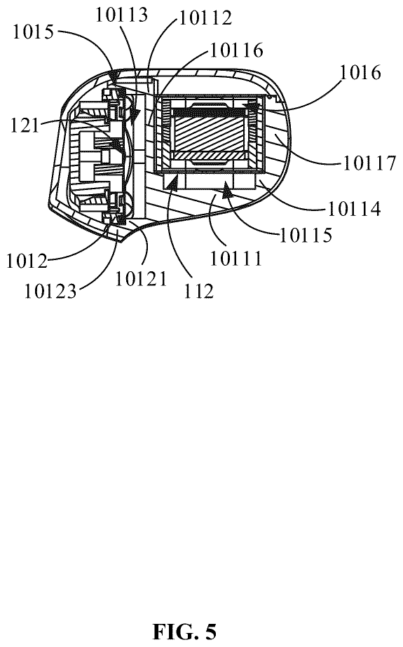

Referring to FIGS. 3 and 5, in some embodiments, the first housing 101 includes a main housing 1011 and a first annular flange 1012. The main housing 1011 includes a bottom wall portion 10111 and an annular side wall portion 10112 connected to each other. The first annular flange 1012 is protrudingly disposed on an outer side of the annular side wall portion 10112. The bottom wall portion 10111 and the annular side wall portion 10112 enclose at least a part of the second accommodating cavity 104. The first annular flange 1012 and a part of the annular side wall portion 10112 form at least a part of the first accommodating cavity 103. That is, the bottom wall portion 10111 and the annular side wall portion 10112 enclose the second sub-accommodating cavity 1016, and the first annular flange 1012 and the part of the annular side wall portion 10112 enclose the first sub-accommodating cavity 1015. The bottom wall portion 10111 is disposed opposite to the second opening 1018, and the part of the annular side wall portion 10112 is disposed opposite to the first opening 1017. The first annular flange 1012 is disposed on a side of the annular side wall portion 10112 close to the first accommodating cavity 103, and the part of the annular side wall portion 10112 forms the bottom wall of the first accommodating cavity 103.

In some embodiments, an inner surface of the first annular flange 1012 is provided with a first step portion 10121. The first step portion 10121 is configured to support a bottom end surface 121 of the air-conduction speaker 12 facing the annular side wall portion 10112. It may be understood that a surface of the air-conduction speaker 12 facing the annular side wall portion 10112 is the bottom end surface 121 of the air-conduction speaker 12. The bottom end surface 121 of the air-conduction speaker 12 abuts against a side of the first step portion 10121 facing the first opening 1017. The first accommodating cavity 103 includes a first groove 10113. When the air-conduction speaker 12 is accommodated in the first accommodating cavity 103, a gap space between the bottom end surface 121 of the air-conduction speaker 12 and the annular side wall portion 10112 is the first groove 10113. The first groove 10113 provides a vibration space for the diaphragm of the air-conduction speaker 12.

In some embodiments, an inner surface of the annular side wall portion 10112 is provided with a second step portion 10114. The second step portion 10114 is configured to support a bottom end surface 112 of the bone-conduction speaker 11 facing the bottom wall portion 10111. It may be understood that a surface of the bone-conduction speaker 11 facing the bottom wall portion 10111 is the bottom end surface 112 of the bone-conduction speaker 11. The bottom end surface 112 of the bone-conduction speaker 11 abuts against a side of the second step portion 10114 facing the second opening 1018. The bottom wall portion 10111 is provided with a second groove 10115. The second accommodating cavity 104 includes the second groove 10115. When the bone-conduction speaker 11 is accommodated in the second accommodating cavity 104, a gap space between the bottom end surface 112 of the bone-conduction speaker 11 and the bottom wall portion 10111 is the second groove 10115. The second groove 10115 provides a vibration space for a vibration transmission piece of the bone-conduction speaker 11.

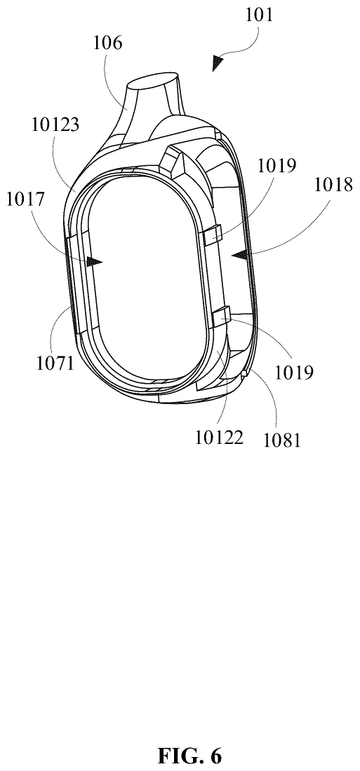

Referring to FIGS. 5 and 6, in some embodiments, the first annular flange 1012 includes an annular wall 10122 and a semi-enclosed portion 10123. The annular wall 10122 is configured to form the first accommodating cavity 103. Along the vibration direction of the bone-conduction speaker 11, the semi-enclosed portion 10123 encloses an outer side of the annular wall 10122 close to the bottom wall portion 10111. A part of an outer surface of the annular wall 10122 close to the semi-enclosed portion 10123 is configured to engage with the second housing 102, and an end surface of the semi-enclosed portion 10123 facing the second housing 102 is configured to engage with the second housing 102. It may be understood that the part of the outer surface of the annular wall 10122 close to the semi-enclosed portion 10123 and the end surface of the semi-enclosed portion 10123 facing the second housing 102 both engage with a side of the main portion 1021 facing the first accommodating cavity 103 and opposite to the extension portion 1022.

Referring to FIGS. 3, 5, and 8, in some embodiments, the annular side wall portion 10112 includes a first side wall portion 10116 and a second side wall portion 10117 connected to each other. The first side wall portion 10116 is disposed close to the first accommodating cavity 103, and the second side wall portion 10117 is disposed away from the first accommodating cavity 103. The first annular flange 1012 is protrudingly disposed on an outer side of the first side wall portion 10116. It may be understood that the first side wall portion 10116 is a part that separates the first accommodating cavity 103 and the second accommodating cavity 104. An end surface of the annular side wall portion 10112 and the end surface of the semi-enclosed portion 10123 are smoothly connected to form a first annular curved surface 1010, and the end surface of the annular side wall portion 10112 is configured to engage with the second housing 102. An end surface of the main portion 1021 facing the first accommodating cavity 103 and an end surface of the extension portion 1022 are smoothly connected to form a second annular curved surface 1026. The second annular curved surface 1026 and the first annular curved surface 1010 fit together and form the engagement seam, so that the engagement seam does not contact the face of the user, reducing the risk of the engagement seam pinching the face of the user.

Referring to FIGS. 3 and 6, in some embodiments, the end surface of the semi-enclosed portion 10123 gradually moves away from an end surface of the annular wall 10122 along a direction along a depth direction of the first accommodating cavity 103 and toward the second accommodating cavity 104. That is, along a direction from the first opening 1017 toward the first side wall portion 10116, an end surface of the semi-enclosed portion 10123 facing the second accommodating cavity 104 gradually moves away from the end surface of the annular wall 10122. The end surface of the semi-enclosed portion 10123 and the axial direction of the first opening 1017 form an angle, so as to smoothly transition and connect with the end surface of the annular side wall portion 10112, forming the first annular curved surface 1010.

In some embodiments, the first housing 101 and the second housing 102 are fixed by a limit structure. The limit structure may include a cooperation structure of a limit block and a limit groove, a cooperation structure of a bolt and a pin, or a cooperation structure of magnetic attraction, etc. The first housing 101 and the second housing 102 are mutually limited and fixed by the limit structure, thereby improving the assembly stability between the first housing 101 and the second housing 102.

Referring to FIGS. 3, 6, and 7, in some embodiments, on a side away from the second accommodating cavity 104, a first limit block 1071 is protrudingly disposed on the end surface of the annular wall 10122. The second housing 102 is provided with a corresponding first limit groove 1072. The first limit block 1071 is clamped in the first limit groove 1072. The first limit block 1071 protrudes from the end surface of the annular wall 10122 on the side away from the second accommodating cavity 104 toward a direction away from the first accommodating cavity 103, and the first limit block 1071 extends along a circumferential direction of the annular wall 10122. The first limit groove 1072 is correspondingly disposed on the end surface of the main portion 1021 facing the first accommodating cavity 103 and opposite to the extension portion 1022. The first limit block 1071 may extend straight for a certain length along the circumferential direction of the annular wall 10122, that is, the first limit block 1071 may overall have a cuboid structure, and the first limit groove 1072 has a corresponding complementary structure, thereby simplifying the design and manufacture of the first limit block 1071 and the first limit groove 1072.

In some embodiments, a position of the first limit block 1071 and a position of the first limit groove 1072 may be swapped. For example, the first limit block 1071 may be protrudingly disposed on the second housing 102, and the first limit groove 1072 may be disposed on the end surface of the annular wall 10122. The present disclosure does not limit the specific details.

Referring to FIGS. 6 and 8, in some embodiments, the first housing 101 includes a support block 1019. The support block 1019 is configured to support the second housing 102. The support block 1019 may be protrudingly disposed on an outer surface of the annular wall 10122.

In some embodiments, a plurality of support blocks 1019 are arranged in a spaced manner. The plurality of support blocks 1019 may be arranged in a spaced manner along the circumferential direction of the annular wall 10122, and each support block 1019 is disposed parallel to the axial direction of the first opening 1017. For example, a count of the support blocks 1019 may be two or three. Two or three support blocks 1019 are arranged in a spaced manner on an outer side of the annular wall 10122 close to the second accommodating cavity 104. The annular wall 10122 includes two opposite plane walls and two opposite arc walls. The plane walls and the arc walls are alternately connected in sequence to form the annular wall 10122. When the count of the support blocks 1019 is two, the two support blocks 1019 may be disposed on the plane walls close to the second accommodating cavity 104. When the count of the support blocks 1019 is three, two of the three support blocks 1019 may be disposed on the plane walls close to the second accommodating cavity 104, and the remaining one support block 1019 may be disposed on one of the arc walls. The count of the support blocks 1019 may also be 4, 5, or others. The support blocks 1019 may all be disposed on the plane walls or all on the arc walls. The count and arrangement manner of the support blocks 1019 are not limited thereto.

In some embodiments, as gradually approaching the second accommodating cavity 104, heights of the plurality of support blocks 1019 on the outer surface of the annular wall 10122 gradually increase. That is, the heights of the plurality of support blocks 1019 away from the second accommodating cavity 104 are less than the heights of the plurality of support blocks 1019 close to the second accommodating cavity 104.

In some embodiments, an inner surface of the second housing 102 is provided with a third groove 1024. The third groove 1024 is configured to mate with the support block 1019. The third groove 1024 is disposed at the connection between the main portion 1021 and the extension portion 1022. When the second housing 102 engages with the first housing 101, the support block 1019 is embedded in the third groove 1024. The cooperation between the support block 1019 and the third groove 1024 can further improve the stability when the first housing 101 and the second housing 102 are engaged.

In some embodiments, along the vibration direction of the bone-conduction speaker 11 and on a side close to the second accommodating cavity 104, a protrusion (not shown) is disposed on the outer surface of the annular wall 10122. The protrusion extends circumferentially along the annular wall 10122. An inner surface of the second housing 102 is provided with a fourth groove (not shown). The protrusion mates with the fourth groove. It may be understood that in the embodiment, the support block 1019 is not provided on the annular wall 10122, and the third groove 1024 is not provided on the inner surface of the second housing 102. The protrusion is disposed along a direction perpendicular to the support block 1019 described in the above embodiment, and the connection between the main portion 1021 and the extension portion 1022 is correspondingly provided with the fourth groove. The cooperation between the protrusion and the fourth groove can further improve the stability when the first housing 101 and the second housing 102 are engaged, and can also ensure better sealing between the first accommodating cavity 103 and the second accommodating cavity 104.

In some embodiments, the protrusion and the fourth groove may be connected by an adhesive. The connection between the protrusion and the fourth groove by the adhesive can further improve the sealing of the housing assembly 10. In addition, the fourth groove can further increase a bonding area of the adhesive, thereby improving the reliability of the assembly of the first housing 101 and the second housing 102.

Referring to FIGS. 3 and 6, in some embodiments, at least on a side away from the semi-enclosed portion 10123, the end surface of the annular wall 10122 and the outer surface of the annular wall 10122 are connected by a chamfered surface. The connection of the end surface of the annular wall 10122 and the outer surface of the annular wall 10122 by the chamfered surface allows the support block 1019 to be more smoothly embedded into the third groove 1024 when the second housing 102 engages with the first housing 101, and can also prevent stress concentration on the second housing 102 when the end surface of the annular wall 10122 and the outer surface of the annular wall 10122 are directly connected at a right angle. In addition, the chamfered surface may be coated with the adhesive to bond the first housing 101 and the second housing 102.

Referring to FIGS. 6 and 8, in some embodiments, on a side away from the first accommodating cavity 103, a second limit block 1081 is protrudingly disposed on the end surface of the annular side wall portion 10112. The second housing 102 is provided with a corresponding second limit groove 1082. The second limit block 1081 is clamped in the second limit groove 1082. The second limit block 1081 is disposed on an end surface of the second side wall portion 10117. The second limit groove 1082 is disposed on a side of the extension portion 1022 away from the main portion 1021. The cooperation between the second limit block 1081 and the second limit groove 1082 enables the extension portion 1022 to better seal the second accommodating cavity 104, thereby improving the sealing of the housing assembly 10.

Referring to FIG. 3, in some embodiments, the first housing 101 is provided with an ear hook connecting portion 106. In the vibration direction of the air-conduction speaker 12, the bone-conduction speaker 11 is closer to the ear hook connecting portion 106 than the air-conduction speaker 12. In this case, the shaking of the core assembly 1 can be reduced, so that the bone-conduction speaker 11 has a better wearing effect in scenarios such as exercise, thereby improving the sound quality. In some embodiments, the ear hook connecting portion 106 extends from one end of the main housing 1011 in a direction away from the main housing 1011. In a projection direction parallel to the extension direction of the ear hook connecting portion 106, a projection of the ear hook assembly 2 falls within the second accommodating cavity 104.

In some embodiments, the bone-conduction speaker 11 needs to be electrically connected to a control circuit and a power source through a wire. By setting the bone-conduction speaker 11 closer to the ear hook connecting portion 106 compared with the air-conduction speaker 12, the wire between the bone-conduction speaker 11 and the control circuit and the wire between the bone-conduction speaker 11 and the power source can be shortened, thereby reducing problems such as increased resistance due to the wire being too long and shaking of the core assembly 1, and reducing electrical connection problems caused by wire breakage or poor contact, thus improving the reliability of the electrical connection.

In some embodiments, the air-conduction speaker 12 also needs to be electrically connected to the control circuit and the power source through the wire. The wire may further pass through the first housing 101 and the second housing 102 to further enable the air-conduction speaker 12 to be powered.

In some embodiments, the housing assembly 10 is further provided with a pressure relief hole for communicating the first accommodating cavity 103 with an external environment. On a reference plane perpendicular to the vibration direction of the bone-conduction speaker 11, the bone-conduction speaker 11 is a rounded rectangle. The rounded rectangle refers to a graphic formed by rounding the right angles of a rectangle. In some embodiments, the pressure relief hole and the ear hook connecting portion 106 are respectively disposed at rounded corner positions on both sides of a diagonal of the bone-conduction speaker 11. In some embodiments, a connecting line between a center of the pressure relief hole and a center of a wire routing hole for routing the wire of the bone-conduction speaker 11 is respectively disposed on the diagonal of the bone-conduction speaker 11. In this case, a space at the rounded corner transition of the housing assembly 10 can be fully utilized to create the pressure relief hole and the wire routing hole, thereby conducive to making the structure of the core assembly 1 more compact.

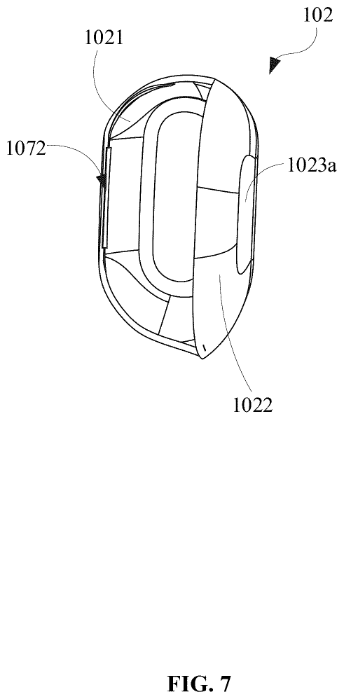

Referring to FIGS. 3 and 7, in some embodiments, the second housing 102 has a planar contact area 1023a contacting the face of the user in a use state. In a normal direction of the planar contact area 1023a, a height difference between the planar contact area 1023 a and the engagement seam is greater than 0.5 mm. That is, the engagement seam and the planar contact area 1023a are not in the same plane, thereby ensuring that when the earphone 100a is worn, the position of the engagement seam does not contact the face of the user, and thus avoiding that sweat during use may enter the housing assembly through the engagement seam. The planar contact area 1023a may be a planar part of the contact area 1023. In this case, the area of the extension portion 1022 can be appropriately increased, which is conducive to reliably and firmly assembling the second housing 102 on the first housing 101, and reducing the possibility of the second housing 102 falling off during use.

Referring to FIGS. 3 and 5, in some embodiments, the bone-conduction speaker 11 has an upper end surface 111 and a bone-conduction bottom end surface 112 oppositely disposed in the vibration direction of the bone-conduction speaker 11. A center axis of the air-conduction speaker 12 is located between the upper end surface 111 and the bone-conduction bottom end surface 112, and a ratio of a distance between the center axis and the upper end surface 111 to a distance between the upper end surface 111 and the bone-conduction bottom end surface 112 is 40%-70%. The center axis of the air-conduction speaker 12 may be parallel to the vibration direction of the air-conduction speaker 12. That is, the air-conduction speaker 12 may be disposed close to a center of the bone-conduction speaker 11. Compared with the air-conduction speaker 12 being disposed close to the upper end surface 111 or the bone-conduction bottom end surface 112 of the bone-conduction speaker 11, this can further reduce the volume of the core assembly 1, making the structure of the core assembly 1 more compact.

In some embodiments, the ratio of the distance between the center axis of the air-conduction speaker 12 and the upper end surface 111 of the bone-conduction speaker 11 to the distance between the upper end surface 111 and the bone-conduction bottom end surface 112 of the bone-conduction speaker 11 is 40%, 45%, 50%, 55%, 60%, 65%, 70%, etc. When the ratio of the distance between the center axis of the air-conduction speaker 12 and the upper end surface 111 of the bone-conduction speaker 11 to the distance between the upper end surface 111 and the bone-conduction bottom end surface 112 of the bone-conduction speaker 11 is 50%, the first accommodating cavity 103 and the vibration transmission piece of the bone-conduction speaker 11 (the vibration transmission piece of the bone-conduction speaker 11 is substantially perpendicular to the vibration direction of the bone-conduction speaker 11) are overall distributed in a T-shape, so that the overall volume of the core assembly 1 is minimized and the structure is most compact.

In some embodiments, the vibration direction of the bone-conduction speaker 11 is perpendicular to the center axis of the air-conduction speaker 12. In this case, the possibility of interference between the bone-conduction speaker 11 and the air-conduction speaker 12 during operation can be reduced.

As described above, the air-conduction speaker 12 and the bone-conduction speaker 11 are arranged crosswise. In general, the distance between the upper end surface 111 and the bone-conduction bottom end surface 112 of the bone-conduction speaker 11 may be greater than a radial dimension of the air-conduction speaker 12 perpendicular to the center axis direction. Therefore, a structural shape of the housing assembly 10 needs to be improved to increase the space utilization inside the housing assembly 10.

In summary, in some embodiments of the present disclosure, the earphone 100a may include the housing assembly 10, the bone-conduction speaker 11, and the air-conduction speaker 12. The housing assembly 10 may include the first housing 101 and the second housing 102. The second housing 102 may engage with the first housing 101, and the first housing 101 and the second housing 102 mate with each other to form the first accommodating cavity 103 and the second accommodating cavity 104. The air-conduction speaker 12 is disposed in the first accommodating cavity 103, and the bone-conduction speaker 11 is disposed in the second accommodating cavity 104. The second housing 102 is configured to contact the face of the user in a wearing state, and the engagement seam between the first housing 101 and the second housing 102 does not contact the face of the user.

By controlling the engagement seam of the housing assembly 10 not to contact the face of the user, the risk of the engagement seam of the housing assembly 10 pinching the face of the user can be reduced, and additionally, the risk of sweat from the face of the user entering the housing assembly 10 through the engagement seam can be further reduced.

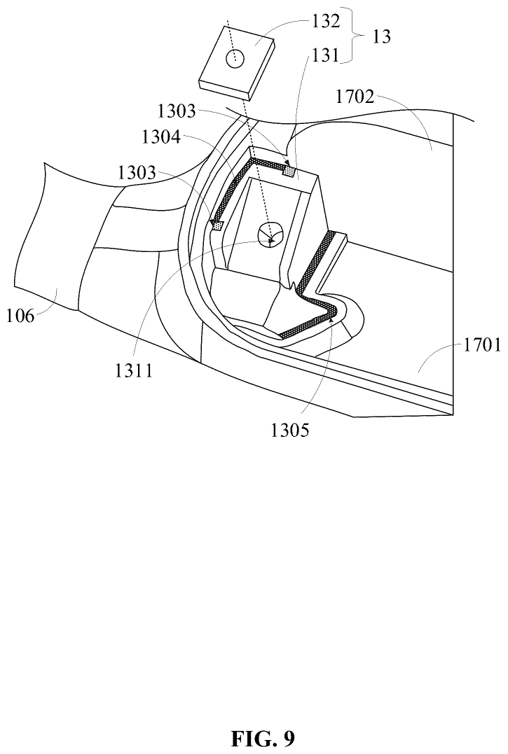

In addition, as described above, referring to FIG. 9, the core assembly 1 may include the housing assembly 10 and a microphone assembly 13. The housing assembly 10 may have the second accommodating cavity 104. The microphone assembly 13 may be disposed in the second accommodating cavity 104.

In some embodiments, the housing assembly 10 is provided with one or two sound inlet holes (not shown). The microphone assembly 13 may be configured to collect external sound input through the sound inlet holes. Sound inlet ends of the two sound inlet holes may be spaced apart from each other, and sound outlet ends of the two sound inlet holes may communicate with each other. The sound inlet end of the sound inlet hole refers to an end where external sound enters the sound inlet hole. The sound outlet end of the sound inlet hole refers to an end where external sound flows out after passing through the sound inlet hole.

The microphone assembly 13 may include a support base 131 and a microphone 132. The support base 131 may be provided with a sound guide channel 1311. A sound inlet end of the sound guide channel 1311 may communicate with the sound outlet ends of the two sound inlet holes. The microphone 132 may be disposed at a sound outlet end of the sound guide channel 1311. The sound inlet end of the sound guide channel 1311 refers to an end where external sound enters the sound guide channel 1311 after passing through the sound inlet holes. The sound outlet end of the sound guide channel 1311 refers to an end where external sound flows out after passing through the sound inlet holes and the sound guide channel 1311.

In this case, sound can enter the microphone assembly 13 in the second accommodating cavity 104 through the two sound inlet holes, to improve the sound pickup effect of the microphone assembly 13. In addition, when there is a large airflow following sound entering the sound inlet holes during sound pickup, the airflow can enter the housing assembly 10 through one of the sound inlet holes and flow out through the other sound inlet hole, thereby reducing wind noise during sound pickup.

In some embodiments, the sound guide channel 1311 is arranged in a bent shape. In this case, a length of the sound guide channel 1311 can be increased, a speed of the airflow can be slowed down, and thus the influence of wind noise can be reduced.

In some embodiments, the housing assembly 10 is provided with a support surface 1701 and an abutting surface 1702. A bottom surface of the support base 131 may be supported on the support surface 1701, and a side surface of the support base 131 may abut against the abutting surface 1702.

In some embodiments, a connection between the abutting surface 1702 and the side surface of the support base 131 may be provided with a first sealant 1303, a second sealant 1304, and a third sealant 1305. The first sealant 1303 may seal a gap between the side surface of the support base 131 and the abutting surface 1702. The second sealant 1304 may at least seal a gap between a top surface of the support base 131 and the abutting surface 1702. The third sealant 1305 may seal a gap between the bottom surface of the support base 131 and the support surface 1701. Thus, the possibility of moisture entering the housing assembly 10 from the gap between the support base 131 and the support surface 1701 and the gap between the support base 131 and the abutting surface 1702 can be reduced.

That is, the first sealant 1303, the second sealant 1304, and the third sealant 1305 can isolate an interior of the housing assembly 10 from the sound inlet holes or the sound guide channel 1311, to reduce the possibility of moisture in the sound inlet holes or the sound guide channel 1311 entering the interior of the housing assembly 10 and causing the electronic components inside the housing assembly 10 (e.g., the microphone 132) to become damp.

The above are only some embodiments of the present disclosure, and do not limit the protection scope of the present disclosure. Any equivalent device or equivalent process transformation made by using the description and drawings of the present disclosure, or directly or indirectly applied in other related technical fields, shall be similarly included in the patent protection scope of the present disclosure.

The above are only embodiments of the present disclosure, and do not limit the patent scope of the present disclosure. Any equivalent structure or equivalent process transformation made by using the description and drawings of the present disclosure, or directly or indirectly applied in other related technical fields, shall be similarly included in the patent protection scope of the present disclosure.

1. An earphone, comprising:
a housing assembly, comprising a first housing and a second housing, wherein
the second housing engages with the first housing; and
the first housing and the second housing mate with each other to form a first accommodating cavity and a second accommodating cavity;
an air-conduction speaker, disposed in the first accommodating cavity; and
a bone-conduction speaker, disposed in the second accommodating cavity, wherein the second housing is configured to contact a face of a user in a wearing state, and an engagement seam between the first housing and the second housing does not contact the face of the user.

2. The earphone according to claim 1, wherein
the first housing comprises a first sub-accommodating cavity and a second sub-accommodating cavity, the first sub-accommodating cavity being at least a part of the first accommodating cavity and the second sub-accommodating cavity being at least a part of the second accommodating cavity;
the first sub-accommodating cavity comprises a first opening, the second sub-accommodating cavity comprises a second opening, and an axial direction of the first opening and an axial direction of the second opening form an angle.

3. The earphone according to claim 2, wherein
the second housing comprises a main portion and an extension portion, and the main portion and the extension portion form an integral structure;
the main portion covers the first opening and mates with the first housing to form the first accommodating cavity, and the extension portion covers the second opening and mates with the first housing to form the second accommodating cavity.

4. The earphone according to claim 2, wherein
at least a part of the air-conduction speaker is disposed in the first sub-accommodating cavity through the first opening;
at least a part of the bone-conduction speaker is disposed in the second sub-accommodating cavity through the second opening;
an axial direction of the air-conduction speaker is the same as the axial direction of the first opening; and
an axial direction of the bone-conduction speaker is the same as the axial direction of the second opening.

5. The earphone according to claim 4, wherein the axial direction of the first opening is perpendicular to the axial direction of the second opening.

6. The earphone according to claim 3, wherein
an outer contour of the main portion is frustum-shaped, and a cross-section of the extension portion in a plane perpendicular to an extension direction of the extension portion is C-shaped; and/or
in a direction perpendicular to both a vibration direction of the air-conduction speaker and a vibration direction of the bone-conduction speaker, a shape of a projection of the second housing is L-shaped.

7. The earphone according to claim 1, wherein the first housing comprises a main housing and a first annular flange, wherein
the main housing comprises a bottom wall portion and an annular side wall portion connected to each other;
the first annular flange is protrudingly disposed on an outer side of the annular side wall portion;
the bottom wall portion and the annular side wall portion enclose at least a part of the second accommodating cavity; and
the first annular flange and a part of the annular side wall portion form at least a part of the first accommodating cavity.

8. The earphone according to claim 7, wherein
an inner surface of the first annular flange is provided with a first step portion; the first step portion being configured to support a bottom end surface of the air-conduction speaker facing the annular side wall portion; and
the annular side wall portion is provided with a first groove included in the first accommodating cavity.

9. The earphone according to claim 7, wherein
an inner surface of the annular side wall portion is provided with a second step portion; the second step portion being configured to support a bottom end surface of the bone-conduction speaker facing the bottom wall portion; and
the bottom wall portion is provided with a second groove included in the second accommodating cavity.

10. The earphone according to claim 7, wherein
the first annular flange comprises an annular wall and a semi-enclosed portion, the annular wall being configured to form the first accommodating cavity;
along the vibration direction of the bone-conduction speaker, the semi-enclosed portion encloses an outer side of the annular wall close to the bottom wall portion; and
a part of an outer surface of the annular wall close to the semi-enclosed portion is configured to engage with the second housing, and an end surface of the semi-enclosed portion facing the second housing is configured to engage with the second housing.

11. The earphone according to claim 10, wherein
the annular side wall portion comprises a first side wall portion and a second side wall portion connected to each other, and the first annular flange is protrudingly disposed on an outer side of the first side wall portion; and
an end surface of the annular side wall portion and the end surface of the semi-enclosed portion are smoothly connected to form a first annular curved surface, and the end surface of the annular side wall portion is configured to engage with the second housing.

12. The earphone according to claim 10, wherein the end surface of the semi-enclosed portion gradually moves away from an end surface of the annular wall along a direction along a depth direction of the first accommodating cavity and toward the second accommodating cavity.

13. (canceled)

14. The earphone according to claim 10, wherein
on a side away from the second accommodating cavity, a first limit block is protrudingly disposed on the end surface of the annular wall; and
the second housing is provided with a corresponding first limit groove, the first limit block being clamped in the first limit groove.

15. (canceled)

16. The earphone according to claim 10, wherein along the vibration direction of the bone-conduction speaker and on a side close to the second accommodating cavity, a support block is disposed on an outer surface of the annular wall, the support block being configured to support the second housing.

17. The earphone according to claim 16, wherein
a plurality of support blocks are arranged in a spaced manner; and/or
as gradually approaching the second accommodating cavity, heights of the plurality of support blocks on the outer surface of the annular wall gradually increase; and/or
an inner surface of the second housing is provided with a third groove, the third groove being configured to mate with the support block.

18. The earphone according to claim 10, wherein
along the vibration direction of the bone-conduction speaker and on a side close to the second accommodating cavity, a protrusion is disposed on the outer surface of the annular wall; and
the protrusion extends circumferentially along the annular wall, an inner surface of the second housing is provided with a fourth groove, and the protrusion mates with the fourth groove.

19. (canceled)

20. The earphone according to claim 10, wherein at least on a side away from the semi-enclosed portion, the end surface of the annular wall and the outer surface of the annular wall are connected by a chamfered surface.

21. The earphone according to claim 7, wherein
on a side away from the first accommodating cavity, a second limit block is protrudingly disposed on the end surface of the annular side wall portion; and
the second housing is provided with a corresponding second limit groove, the second limit block being clamped in the second limit groove.

22. (canceled)

23. The earphone according to claim 1, wherein
the second housing has a planar contact area contacting the face of the user in a use state; and
in a normal direction of the planar contact area, a height difference between the planar contact area and the engagement seam is greater than 0.5 mm.

24. The earphone according claim 1, wherein
the bone-conduction speaker has an upper end surface and a bone-conduction bottom end surface oppositely disposed in the vibration direction of the bone-conduction speaker;
a center axis of the air-conduction speaker is located between the upper end surface and the bone-conduction bottom end surface; and
a ratio of a distance between the center axis and the upper end surface to a distance between the upper end surface and the bone-conduction bottom end surface is 40%-70%.
